(19) United States
(12) Patent Application Publication
(10) Pub. No.: US 2019/0105886 A1
(43) Pub. Date: Apr. 11, 2019

(54) SHAPE MEMORY POLYURETHANE COMPOSITION AND LAMINATE USING THE SAME

(71) Applicant: National Taipei University of Technology, Taipei (TW)

(72) Inventors: SYANG-PENG RWEI, Taipei (TW); CHIEN-HUI WU, Taipei (TW); Whe-Yi Chiang, Taipei (TW)

(73) Assignee: National Taipei University of Technology, Taipei (TW)

(21) Appl. No.: 16/153,911

(22) Filed: Oct. 8, 2018

(30) Foreign Application Priority Data
Oct. 11, 2017 (TW) 106134670

(51) Int. Cl. B32B 27/40; B32B 5/02; C08G 18/32; C08G 18/72

(52) U.S. Cl. CPC B32B 27/40; B32B 5/022; B32B 5/026; B32B 2307/724; C08G 18/72; C08G 2280/00; B32B 2437/00; C08G 18/3203

(57) ABSTRACT

The present invention provides a shape memory polyurethane composition and laminate using the same. The shape memory polyurethane composition at least comprises a polyurethane synthesized by polymerization of at least a polyol having at least two functional groups, a diisocyanate having at least two functional groups and a chain extender having at least two functional groups wherein the molar ratio of the diisocyanate:polyol:chain extender is 2˜3:1:1˜2, the NCO/OH molar ratio is 0.95˜1.1, the weight average molecular weight is 50,000˜300,000, the polyurethane has a first phase transition temperature being in the range of 40° C.˜60° C. and the storage elastic modulus at the temperature less than or equal to the first phase transition temperature is more than or equal to 10⁹ Pa.

### BACKGROUND OF THE INVENTION

### a. Field of the Invention

The invention relates to a shape memory polyurethane composition and laminate using the same, particularly to a shape memory polyurethane composition for coating on a fabric and laminate using the same.

### b. Description of the Related Art

Bra cups usually are made of PU (polyurethane) foam, but typical PU foam is prone to yellowing, and is easily deformed with increasing usage time and number of washings. The use of a three-dimensional fabric (3D fabric or spacer fabric) instead of PU foam provides elasticity from the Z-axis and is made of polyester which will not be yellowing. Furthermore, the 3D fabric bras (mesh is less than 0.2 mm; Z-axis is 2-3 mm long) are composed of a sandwich fiber structure. The main feature of the 3D fabric is that the mesh is small and dense and the Z-axis is much shorter than the mesh (about 2-3 mm). Because of its characteristics of embossing and high elasticity, it is mostly used in women's bras and plastic underwear, which can be formed into a cup shape by thermoplastic molding. In addition, the use of a variety of coatings combined with 3D fabrics provides more versatile functions, such as mildew-proof, water-repellent, perspiration wicking, shape memory and the like. In addition, as the weaving method of 3D fabrics develops, the fabric in different regions having different denier regions or different mesh distributions for a pressure garment or a sports underwear.

For example, the prior art (China patent no. CN 103798978A) discloses a shape memory polymer bra including a cup and an attachment, characterized in that the cup is made of a shape memory polymer material, which is formed into a flat plate and then molded into a cup or formed by the injection molding, the softening point is about 45-70° C., and the shape memory polymer is foamed or non-foamed material. The shape memory polymer can be crosslinked trans-polyisoprene, polyester or polyolefin, or non-crosslinked polyurethane or norbornene. The bra has venting holes thereon which have a pore diameter of 1 to 3 mm, and the total area of the venting holes accounts for 10 to 70% of the total area of the shape memory polymer. By heating to a softening point of 45-70° C., it can be reshaped to fit the user's breast size and improve comfort. However, the shaping of the bra requires a mold to achieve permanent deformation, which is higher than the temperature that the user's skin can withstand. It is difficult to perform the pressing on the user as desired by the inventors of the patent, and besides there is no disclosure about the specific composition of the shape memory polymer material.

Furthermore, in the prior art (US patent application No. 20160044971), a bra incorporating a shape memory polymer and a method of manufacturing the same are disclosed. A film layer with holes therein (hole density of 10-90%) composed of a shape memory polymer is used and the movement frequency of the breast of a user between 1 to 100 Hz can be absorbed by the shape memory polymer. The shape memory polymer used in the literature is a polyurethane elastomer, which can be synthesized using a bifunctional diisocyanate, a bifunctional polyalcohol and a bifunctional chain extender with the molar ration of diisocyanate:polyol:chain extender=2.0˜1.10:1.00:1.00˜0.10. The polyurethane has been disclosed such as TW Patent No. 1167593 and thus it is speculated that the force absorption ability near the low frequency (40 Hz) mainly comes from the holes of the film layer. By controlling the hole ratio of the film layer, the vibration absorption function of the bra (refer to FIG. 15-17 in the specification of US20160044971) can be provided, as a sports bra, but the phase change temperature (softening point) near the body temperature cannot provide the shape restoring function to the bra.

A non-patent literature (Polymer chem 2016, 7, 1739) disclosed a thermosensitive or acid-base sensitive shape memory CO₂ type PU obtained by polymerization of polyethylene glycol (PEG), dimethylolpropionic acid (DMPA) and methylene diphenyl diisocyanate (MDI). The glass transition temperatures Tg of the shape memory polymers (having different weight ratios of PEG) are −7.2° C., 13.0° C., and 26.6° C., respectively. However, the storage elastic modulus of the shape memory polymer is gradually decreased from 80 MPa to 10 MPa with increasing temperature from 20 to 60° C. and the sample with 30% PEG has phase transition temperatures at 23.9 and 56.2° C., respectively. However, these characteristics cannot be used as the materials for bras.

### BRIEF SUMMARY OF THE INVENTION

In light of the above background, in order to fulfill the requirements of the industry, one object of the invention provides a shape memory laminate. In addition, the shape memory laminate formed by a shape memory polyurethane composition comprises a shape memory polymer layer on the whole area or a portion of the laminate. The laminate can further comprise a supporting layer at a designed position to provide a push-up function when used as a bra.

According to the present invention, the shape memory polyurethane composition is coated on a three-dimensional fabric (3D fabric or called spacer fabric) or formed into a shape memory film and then laminated on a 3D fabric to fabricate a 3D fabric bra cup instead of the PU foam bra cup. According to the present invention, the 3D fabric bra cup with a coating layer from the shape memory polyurethane composition can be shaped and reshaped by heating and/or cooling and does not need to use any foreign material such as supporting steel wires to maintain the shape. When the bra is deformed, the shape can be restored in a drying machine by heating to the temperature higher than the Tm of the soft segments of PU but lower than Tg of the hard segments of PU.

Other objects and advantages of the invention can be better understood from the technical characteristics disclosed by the invention. In order to achieve one of the above purposes, all the purposes, or other purposes, one embodiment of the invention provides a laminate, comprising a base fabric and a shape memory polymer layer; wherein the shape memory polymer layer is formed by a shape memory polyurethane composition; the shape memory polyurethane composition at least comprises: a polyurethane synthesized by polymerization of at least a polyol having at least two functional groups, a diisocyanate having at least two functional groups and a chain extender having at least two functional groups; the molar ratio of the diisocyanate:polyol:chain extender is 2˜3:1:1˜2, the NCO/OH molar ratio is 0.95˜1.1, the weight average molecular weight is 50,000˜300,000, the polyurethane has a first phase transition temperature being in the range of 40° C.˜60° C., the storage elastic modulus at the temperature less than or equal to the first phase transition temperature is more than or equal to 10⁹ Pa, and the storage elastic modulus at the temperature above (the first phase transition temperature+10° C.) is between 10⁶ Pa and 10⁸ Pa.

Furthermore, one other embodiment of the invention provides a shape memory polyurethane composition, at least comprising: a polyurethane synthesized by polymerization of at least a polyol having at least two functional groups, a diisocyanate having at least two functional groups and a chain extender having at least two functional groups; wherein the molar ratio of the diisocyanate:polyol:chain extender is 2˜3:1:1˜2, the NCO/OH molar ratio is 0.95˜1.1, the weight average molecular weight of the polyurethane is within 50,000˜300,000, the polyurethane has a first phase transition temperature being in the range of 40° C.˜60° C., the storage elastic modulus at the temperature less than or equal to the first phase transition temperature is more than or equal to 10⁹ Pa and the storage elastic modulus at the temperature above (the first phase transition temperature+10° C.) is between 10⁶ Pa and 10⁸ Pa.

According to the present invention, a shape memory polyurethane composition and a laminate using the shape memory polyurethane composition are provided. The shape memory laminate can be formed into a bra cup and the shape of the bra cup can be restored when deformed by heating to the temperature around the phase transition temperature which is about 40° C.˜60° C., for example in a drying machine or hair dryer.

Other objectives, features and advantages of the invention will be further understood from the further technological features disclosed by the embodiments of the invention wherein there are shown and described preferred embodiments of this invention, simply by way of illustration of modes best suitable to carry out the invention.

### BRIEF DESCRIPTION OF THE DRAWINGS

FIG. 1 shows a schematic diagram of the laminate according to one embodiment of the invention.

FIG. 2 shows a side view of the laminate formed into a bra according to one embodiment of the invention.

FIG. 3 shows a side view of the laminate formed into a bra according to another embodiment of the invention.

FIG. 4 shows DSC (differential scanning calorimetric) results of the film formed by the shape memory polyurethane composition according to example 1 and comparison examples.

FIG. 5 shows DMA (dynamic mechanical analysis) results of the film formed by the shape memory polyurethane composition according to example 1 and comparison examples.

FIG. 6 shows the plot of storage elastic modulus versus temperature of the film formed by the shape memory polyurethane composition according to example 1 according to the present invention.

FIG. 7 shows (a) the plot of storage elastic modulus versus temperature at different frequencies and (b) the plot of tan δ versus temperature of the film formed by the shape memory polyurethane composition according to example 1 according to the present invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. Some preferred embodiments of the present invention will now be described in greater detail in the following. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

The shape memory polyurethane composition of the present invention can be used as an agent for surface treatment of a 3D fabric to make the 3D fabric become a shape memory fabric to replace the conventional PU foam bra cup. The shape memory 3D fabric bra cup can be shaped and reshaped by heating and/or cooling and does not need to use any foreign material such as supporting steel wires to maintain the shape. When the bra is deformed, the shape can be restored in a drying machine or hair dryer by heating to the temperature higher than the Tm of the soft segments of PU but lower than Tg of the hard segments of PU.

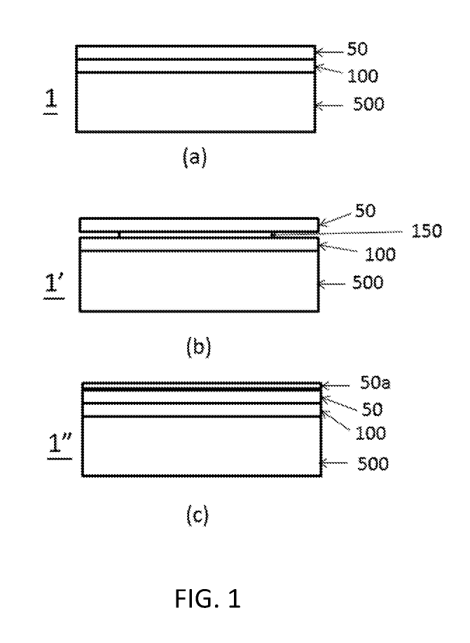

FIG. 1 shows a schematic diagram of the laminate 1 according to one embodiment of the invention. According to one embodiment of the invention, the laminate comprises a base fabric and a shape memory polymer layer. As shown in FIG. 1 (a), the laminate 1 comprises the base fabric 500, the shape memory polymer layer 100 formed on the base fabric 500 and the overcoat layer 50 covering the shape memory polymer layer 100. In another embodiment, as shown in FIG. 1 (b), the laminate 1′ comprises the base fabric 500, the shape memory polymer layer 100, the supporting layer 150 and the overcoat layer 50 where the supporting layer 150 is formed on only a portion of the laminate. When the laminate is used as a bra, the supporting layer 150 is at a designed position to provide a push-up function to have the higher hardness than the shape memory polymer layer 100. As shown in FIG. 1 (c), the laminate 1″ comprises the base fabric 500, the shape memory polymer layer 100, the supporting layer 150, the overcoat layer 50 and the fracture coating layer 50a.

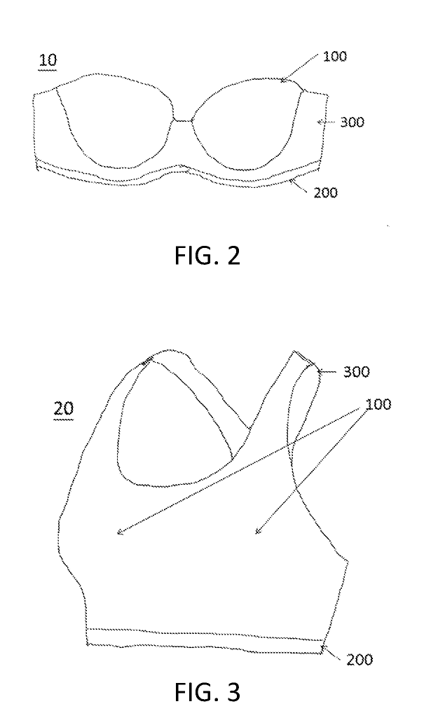

FIG. 2 shows a side view of the laminate formed into a bra according to one embodiment of the invention and FIG. 3 shows a side view of the laminate formed into a bra according to another embodiment of the invention wherein 100 represents the shape memory polymer layer, 200 represents a bra band, and 30 represents the laminate of the present invention containing the shape memory polymer layer.

The shape memory polymer layer 100 is formed by a shape memory polyurethane composition and the shape memory polyurethane composition at least comprises: a polyurethane synthesized by polymerization of at least a polyol having at least two functional groups, a diisocyanate having at least two functional groups and a chain extender having at least two functional groups. The molar ratio of the diisocyanate:polyol:chain extender is 2˜3:1:1˜2, the NCO/OH molar ratio is 0.95˜1.1, the weight average molecular weight is 50,000˜300,000, the polyurethane has a first phase transition temperature being in the range of 40° C.˜60° C., the storage elastic modulus at the temperature less than or equal to the first phase transition temperature is more than or equal to 10⁹ Pa, and the storage elastic modulus at the temperature above (the first phase transition temperature+10° C.) is between 10⁶ Pa and 10⁸ Pa. Specifically, the shape memory polyurethane composition is formed by polymerization of CO₂ type polyol, diisocyanate (for example, methylene diphenyl diisocyanate (MDI)) and a chain extender (for example, glycols such as butanediol (BDO), pentanediol, hexanediol, octanediol, etc.) and dissolving in a solvent such as dimethylformamide (DMF), dimethylacetamide (DMAc), N-methylpyrrolidone (NMP), dimethyl sulfoxide (DMSO), or tetrahydrofuran (THF).

In one embodiment, the polyol is a polyol containing a carbonate moiety and has a weight average molecular weight of 1000˜3000 and the polyurethane has a weight average molecular weight of 80,000˜120,000.

The molar ratio of the diisocyanate:polyol:chain extender is 2˜3:1:1˜2, preferably 2˜2.5:1:1˜1.5, and more preferably 2˜2.1:1:1˜1.1.

The thickness of the shape memory polymer layer 100 can be properly determined according to its applications. For example, it is within 10 μm˜2 mm, preferably 0.05 mm˜2 mm, and more preferably 0.05 mm˜0.5 mm. The shape memory polymer layer 100 can be formed on the surface of the base fabric by a coating, transferring or lamination method. The shape memory polymer layer 100 can be formed on only a portion of the base fabric and can also have holes. The size of the hole of the shape memory polymer layer 100 can be similar to or the same as that of the base fabric or be larger than that of the base fabric. The holes of the shape memory polymer layer 100 can be randomly distributed. Besides, the holes of the shape memory polymer layer 100 can follow the structure of the base fabric or be designed to a specific pattern during the formation of the shape memory polymer layer 100.

The overcoat layer 50 be formed into a film on the shape memory polymer layer 100 by a coating, transferring or lamination method.

The base fabric 500 can be for example a non-woven fabric, knitted fabric or 3D fabric (spacer fabric). Specifically, a 3D fabric with a thickness of 3˜20 mm can be used and the holes and thickness of the 3D fabric can be chosen according to its application. For example, a bra cup laminate uses a 3D fabric having a sandwiched structure with mesh size less than 0.2 mm and a Z-axis length of 2˜3 mm. The so-called 3D fabric (three-dimensional fabric) is a fabric having two surface layers and a middle layer between the two surface layers and the 3D fabric used in the present invention has air permeability of more than 50 cfm according to ASTM D737. When the 3D fabric is used as the base fabric and the laminate is formed into a bra cup shape, the shape memory polymer layer can be a randomly fractured coating film positioned at a portion of the base fabric and the laminate has air permeability of more than 50 cfm according to ASTM D737.

The fracture coating layer 50a can provides functions such as mildew-proof, water-repellent, perspiration wicking, and so on depending on the comprising material to the shape memory laminate. Specifically, a composition containing a water-repellent agent is used to form a coating layer on a fabric and the fabric with the coating layer is dried and then becomes water-repellent. Or, a fracture coating method is used to intentionally form a broken and randomly fractured coating layer on the fabric to make the fabric have the Lotus effect. The fractured coating layer can be fabricated according to the method and machine disclosed by Taiwan patent application no. TW105121170.

The solvent included in the shape memory polyurethane composition can be any solvent that can dissolve polyurethane in the shape memory polyurethane composition. For example, the solvent can be dimethylformamide (DMF), dimethylacetamide (DMAc), N-methylpyrrolidone (NMP), dimethyl sulfoxide (DMSO), or tetrahydrofuran (THF).

In one embodiment, the laminate has hardness more than 50D according ASTM D2240 type D scale.

The application of the laminate of the present invention includes for example shaping belts and bra cups for women's underwear but not limited to the above examples. It can be formed into any shape for any appropriate application.

Examples are shown in the following to further illustrate the present invention in details but the present invention is not limited to the examples.

### Examples

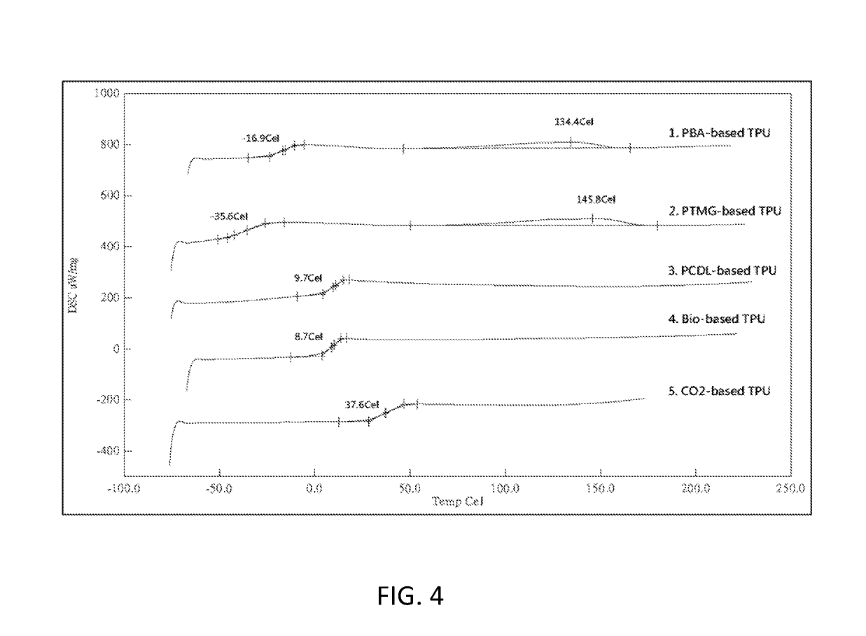

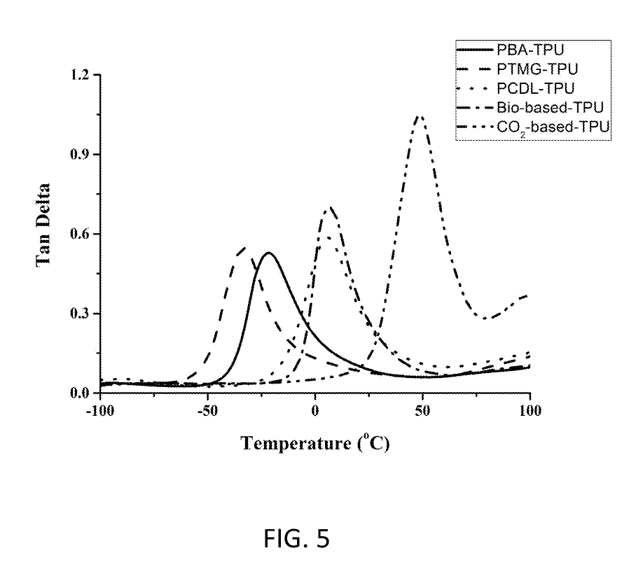

The composition components according to the quantities of use (mass ratio) shown in Table 1 were used. The polyol (Example 1 using polyol B5, Comparative Examples 1 to 4 using polyol B1 to B4) was placed in a vacuum oven. The temperature of the oven was set at 100° C. and the mixture polyol was placed in the oven for 3 hours. The isocyanate (A) (diisocyanate) was placed in an oven at a temperature of 65° C. for 2 hours. A polypropylene beaker was used and an appropriate amount of polyol was putted in and the beaker was placed in an oven at 100° C. to maintain the temperature of the mixture to prevent the polyol from becoming waxy. The polyol was taken out from the oven, the chain extender (C) was added, and the stirring speed was increased from 200 rpm to 600 rpm to stirring the mixture. After stirring to become homogeneous, the mixture was placed in an oven to maintain the temperature of the mixture. Then, the mixture was taken out of the oven and the appropriate amount of isocyanate (diisocyanate) was weighed and added. A stirrer was used to stir the mixture and carry out the reaction. The viscosity rose rapidly, the rotation speed is further increased from 600 rpm to 1200 rpm to stir evenly. Finally, the reaction product was quickly poured into the iron plate coated with Teflon and placed in an oven set at 120° C. to age for 3 hours to obtain polyurethanes PBA-TPU, PTMG-TPU, PCDL-TPU, Bio-based-TPU and CO2-based-TPU. The obtained polyurethanes was dissolved in DMAC to have a composition with a solid content of 30˜40 wt %. The composition was formed into a film. The films were then tested using DSC and DMA. The results of DSC were shown in FIG. 4 and the results of DMA (tan δ versus temperature) were shown in FIG. 5. DSC was performed using Hitachi STINT SII X-DSC7000 device and the conditions: temperature rising range −80° C.˜220° C., temperature rising speed 10° C./min, temperature lowering range 220° C.˜80° C., and temperature lowering speed 10° C./min. One cycle is defined as including one temperature rising and one temperature lowering and two cycles are performed. DMA measurements were performed using a Hitachi DMS 6100 device with a test sample having size of 4*1 cm and a thickness of 0.16 mm. The conditions of the temperature rising speed being 5° C./min in a temperature range of −15° C.˜100° C. were used. The measurement of the weight average molecular weight was conducted using a GPC (gel permeation chromatography) by dissolving the 10˜25 mg of test sample in 5 ml of DMF.

TABLE I

| | Com- | Com- | | | |
|---|---|---|---|---|---|
| | parison | parison | Comparison | Comparison | Example |
| | example 1 | example 2 | example 3 | example 4 | 1 |
| Isocyanate | 100 | 100 | 100 | 100 | 100 |
| A | | | | | |
| Polyol B | B1/50.06 | B2/51.88 | B3/49.88 | B4/53.12 | B5/53.19 |
| Chain | 9.01 | 9.07 | 8.98 | 9.11 | 9.04 |
| extender C | | | | | |
| A/B/C | 2/1/1 | 2/1/1 | 2/1/1 | 2/1/1 | 2/1/1 |
| (molar | | | | | |
| ratio) | | | | | |
| Weight | 2.01 | 2.09 | 2.18 | 2.23 | 1.04 |
| average | | | | | |
| molecular | | | | | |
| weight/10⁵ | | | | | |
| PDI | 1.33 | 1.65 | 1.56 | 1.57 | 1.62 |
| Tg | −21.4° C. | −33.4° C. | 5.3° C. | 6.6° C. | 48.1° C. |
| (DMA*) | | | | | |
| Hardness | 90 | 85 | 88 | 87 | >99 |
| (Shore A) | | | | | (75D) |

B1: PBA 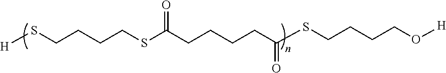
(From Lidyechemical Co.)
B2: PTMG 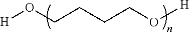
(From Lidyechemical Co.)
B3: PCD 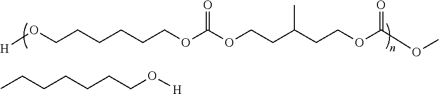
(From Lidyechemical Co.)
B4: PPS (bio-based) 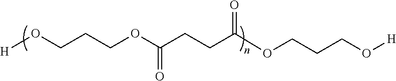
(Taichin Co.)
B5: CO₂-based polyol 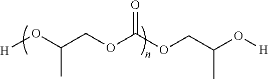
(Novomer; Converge® polyol 212-10)
Isocyanate A: methylene diphenyl diisocyanate (MDI)
Chain extender C: butanediol (BDO)
*: DMA results from FIG. 5

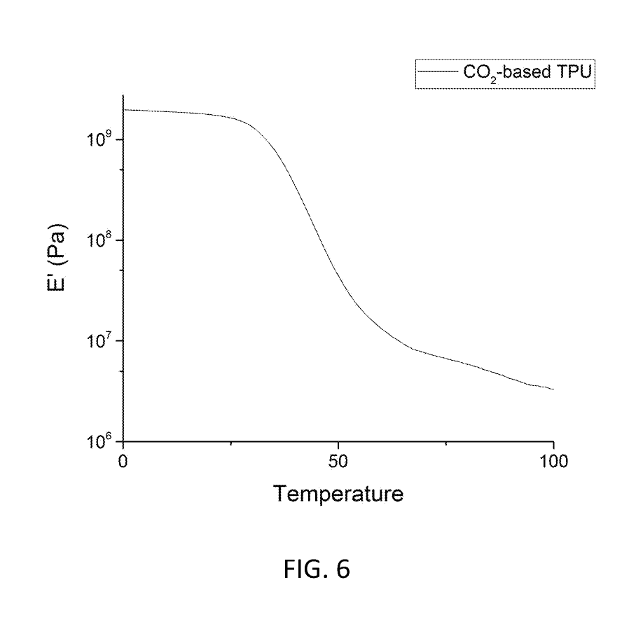

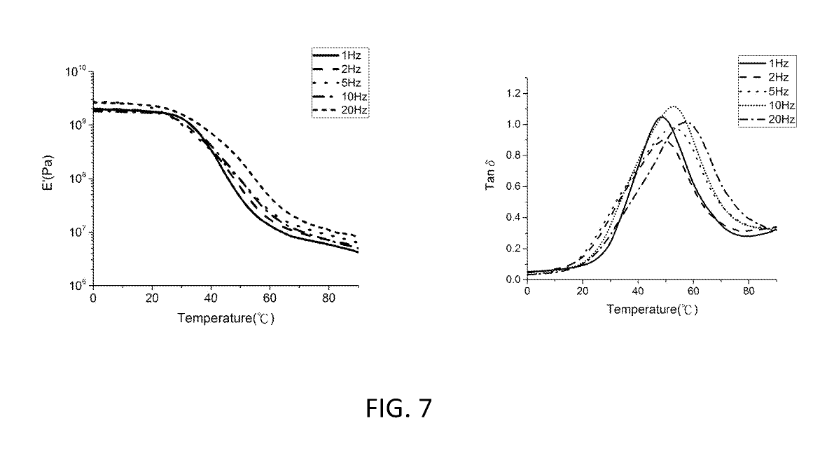

The glass transition temperature of the CO₂-based TPU from the DMA measurement is 48.1° C. (the first phase transition temperature). FIG. 6 shows the plot of storage elastic modulus versus temperature of the film formed by the shape memory polyurethane composition according to example 1 according to the present invention. FIG. 7 shows (a) the plot of storage elastic modulus versus temperature at different frequencies and (b) the plot of tan δ versus temperature of the film formed by the shape memory polyurethane composition (CO₂-based TPU) according to example 1 according to the present invention.

Shape Memory Test

The test sample film with a thickness of 0.16 mm was used. The film was deformed to have a deformation of 19.05% and then fixed after released. After fixation for two days, the deformation became 16.67% and the sample was placed in a 70° C. hot water bath to restore its original length. The fixation rate is 87.5% (16.67%/19.05%*100%) and the recovery is 100%. The sample made from the comparison examples does not have the shape memory property.

In conclusion, according to the present invention, a shape memory polyurethane composition and a laminate using the shape memory polyurethane composition are provided. The shape memory laminate can be formed into a bra cup and the shape of the bra cup can be restored when deformed by heating to the temperature around the phase transition temperature which is about 40° C.˜60° C., for example in a drying machine or hair dryer.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A laminate, comprising a base fabric and a shape memory polymer layer;
wherein the shape memory polymer layer is formed by a shape memory polyurethane composition;
the shape memory polyurethane composition at least comprises: a polyurethane synthesized by polymerization of at least a polyol having at least two functional groups, a diisocyanate having at least two functional groups and a chain extender having at least two functional groups;
the molar ratio of the diisocyanate:polyol:chain extender is 2˜3:1:1˜2, the NCO/OH molar ratio is 0.95˜1.1, the weight average molecular weight is 50,000˜300,000, the polyurethane has a first phase transition temperature being within 40° C.˜60° C., the storage elastic modulus at the temperature less than or equal to the first phase transition temperature is more than or equal to 10⁹ Pa, and the storage elastic modulus at the temperature above (the first phase transition temperature+10° C.) is between 10⁶ Pa and 10⁸ Pa.

2. The laminate as claimed in claim 1, wherein the base fabric is a three-dimensional fabric having two surface layers and a middle layer between the two surface layers and the three-dimensional fabric has air permeability of more than 50 cfm according to ASTM D737.

3. The laminate as claimed in claim 1, wherein the shape memory polymer layer is formed into a continuous film on a portion of the base fabric.

4. The laminate as claimed in claim 2, wherein the laminate is formed in to a bra shape and the shape memory polymer layer is formed into a continuous film on a portion of the base fabric.

5. The laminate as claimed in claim 1, wherein the shape memory polymer layer is formed into a randomly-fractured film on a portion of the base fabric and the laminate has air permeability of more than 50 cfm according to ASTM D737.

6. The laminate as claimed in claim 2, wherein the laminate is formed in to a bra shape and the shape memory polymer layer is formed into a randomly-fractured film on a portion of the base fabric and the laminate has air permeability of more than 50 cfm according to ASTM D737.

7. The laminate as claimed in claim 1, wherein the polyol is a polyol containing a carbonate moiety and has a weight average molecular weight of 1000˜3000 and the polyurethane has a weight average molecular weight of 80,000˜120,000.

8. The laminate as claimed in claim 1, wherein the laminate has hardness more than 50D according ASTM D2240 type D scale.

9. The laminate as claimed in claim 5, wherein the laminate is water repellent.

10. The laminate as claimed in claim 6, wherein the laminate further comprises a supporting layer on a portion of the base fabric.

11. A shape memory polyurethane composition, at least comprising: a polyurethane synthesized by polymerization of at least a polyol having at least two functional groups, a diisocyanate having at least two functional groups and a chain extender having at least two functional groups;
wherein the molar ratio of the diisocyanate:polyol:chain extender is 2˜3:1:1˜2, the NCO/OH molar ratio is 0.95˜1.1, the weight average molecular weight of the polyurethane is within 50,000˜300,000, the polyurethane has a first phase transition temperature being within 40° C.˜60° C., the storage elastic modulus at the temperature less than or equal to the first phase transition temperature is more than or equal to 10⁹ Pa and the storage elastic modulus at the temperature above (the first phase transition temperature+10° C.) is between 10⁶ Pa and 10⁸ Pa.

12. The shape memory polyurethane composition as claimed in claim 11, further comprising a solvent wherein the solvent can dissolve the polyurethane in the shape memory polyurethane composition and the shape memory polyurethane composition comprises 20˜40% in weight of the polyurethane.

13. The shape memory polyurethane composition as claimed in claim 11, wherein the polyol is a polyol containing a carbonate moiety and has a weight average molecular weight of 1000˜3000, the NCO/OH molar ratio is 0.95˜1.06, the molar ratio of the diisocyanate:polyol:chain extender is 2:1:1.

14. The shape memory polyurethane composition as claimed in claim 12, wherein the polyol is a polyol containing a carbonate moiety and has a weight average molecular weight of 1000˜3000, the NCO/OH molar ratio is 0.95˜1.06, the molar ratio of the diisocyanate:polyol:chain extender is 2:1:1.

15. The shape memory polyurethane composition as claimed in claim 11, wherein the polyurethane is processed by annealing at 80˜100° C. for 20˜24 hours.
